(19) United States
(12) Patent Application Publication
(10) Pub. No.: US 2019/0054465 A1
(43) Pub. Date: Feb. 21, 2019

(54) MICROFLUIDIC DEVICE AND METHOD OF MAKING THE SAME

(71) Applicant: National Tsing Hua University, Hsinchu City (TW)

(72) Inventors: Chien-Chong HONG, Zhubei City (TW); Tong-Miin LIOU, Hsinchu City (TW); Zheng-Lin WANG, Taichung City (TW)

(73) Assignee: National Tsing Hua University, Hsinchu City (TW)

(21) Appl. No.: 15/982,508

(22) Filed: May 17, 2018

(30) Foreign Application Priority Data
Aug. 15, 2017 (TW) 106127619

(51) Int. Cl. B01L 3/00; C09D 123/06; C08J 3/28; C08L 27/18

(52) U.S. Cl. CPC B01L 3/502715; B01L 3/502707; B01L 3/502753; B01L 3/502761; C09D 123/06; C08J 3/28; B01L 2200/0668; B01L 2300/0848; B01L 2300/0877; B01L 2300/12; B01L 2300/047; B01L 2200/027; C08L 27/18

(57) ABSTRACT

A microfluidic device includes a substrate, a microchannel, and a porous filter. The microchannel is formed in the substrate and has a first open end and a second open end distal from the first open end. The porous filter is disposed proximally to the first open end and has a plurality of polymeric microparticles clumping together and partially melt-bonded to each other to form a cluster. A method of making the microfluidic device is also provided.

### CROSS-REFERENCE TO RELATED APPLICATION

This application claims priority of Taiwanese Invention Patent Application No. 106127619, filed on Aug. 15, 2017.

### FIELD

The disclosure relates to a microfluidic device, and more particularly to a microfluidic device including a plurality of polymeric microparticles that are partially melt-bonded to each other, and to a method of making the microfluidic device.

### BACKGROUND

Conventional biomedical sample detection generally involves collecting samples, subjecting the collected samples to pretreatments (e.g., filtration, separation or purification), followed by detection and analysis of the pretreated samples. For instance, a conventional blood sample analysis includes separating a collected whole blood sample into blood cells and plasma by centrifugation, and the obtained plasma is used in subsequent tests. However, operation of huge separating equipment such as a centrifuge requires relatively much time and a large volume (more than 5 mL) of blood sample. Besides, the conventional blood sample analysis cannot be conducted in-situ after the blood sample is collected.

In order to solve the abovementioned problem, biochips were proposed and have been widely researched and developed in recent years. A biochip integrates a microfluidic chip and a detection chip into a single chip on which several steps of biochemical operations, such as pre-treating, mixing, separation and analysis of fluidic samples, can be performed as if the biochip is a miniaturized laboratory. Therefore, the biochip has advantages of being small in size and having the ability to perform in-situ rapid detection of fluidic samples. The microfluidic chip of the biochip is mainly used for separation and transportation of fluidic samples. There is plenty of room for improvement in in-situ separating efficiency of the microfluidic chip.

In 2011, I. K. Dimov et al. proposed a microfluidic blood analysis system (see I. K. Dimov, L. Basabe-Desmonts, J. L. Garcia-Cordero, B. M. Ross, A. J. Ricco, and L. P. Lee, “Stand-alone self-powered integrated microfluidic blood analysis system (SIMBAS),” Lab on a Chip, Vol. 11, No. 5, Mar. 7, 2011, pages 845-850, RSC Publishing, www.rsc.org/loc). The microfluidic blood analysis system is formed with microchannels and filtering trenches that are respectively formed in and depressed relative to the microchannels. When a whole blood sample flows into the microchannel, blood cells will be settled in the trenches by gravity while plasma flows through the microchannels above the trenches, thereby separating the plasma from the blood cells. There remains a need for further improving the separating efficiency and analyte purity of the microfluidic blood analysis system.

In 2012, Chunyu Li et al. proposed a capillary-driven microfluidic device (see Chunyu Li, Chong Liu, Zheng Xu, Jingmin Li, “Extraction of plasma from whole blood using a deposited microbead plug (DMBP) in a capillary-driven microfluidic device,” Biomed Microdevices (2012) 14:565-572). The microfluidic device includes a hydrophilic glass substrate formed with a microchannel. The microchannel is formed with a filtering region where microbeads are naturally deposited to form a cluster. A whole blood sample dropped in the microfluidic device will be driven by capillary force and affinity of the hydrophilic substrate to flow through the filtering region. Blood cells are hindered by and confined in the filtering region, while plasma passes through the filtering region so as to achieve separation. However, since the microbeads are naturally deposited, the cluster of the microbeads in the filtering region may not sustain the relatively high flow pressure generated by the blood sample, and might cause undesired movement among microbeads. In addition, it is difficult to define precisely and consistently a dimension of the cluster of the microbeads in the filtering region, and the cluster of the microbeads has a length of more than 1 mm. Hence, the volume of the extracted plasma is less than 400 nL and extraction efficiency is 5%.

### SUMMARY

Therefore, an object of the disclosure is to provide a microfluidic device that can alleviate at least one of the drawbacks of the prior art.

According to one aspect of the disclosure, a microfluidic device includes a substrate, a microchannel, and a porous filter.

The microchannel is formed in the substrate and has a first open end and a second open end distal from the first open end.

The porous filter is disposed proximally to the first open end and has a plurality of polymeric microparticles clumping together and partially melt-bonded to each other to form a cluster.

According to another aspect of the disclosure, a method of making a microfluidic device includes: preparing a substrate formed with an uncovered channel precursor that is indented from a top surface of the substrate; dropping a solution, which contains a plurality of polymeric microparticles dispersed in a solvent, into a confined region proximal to an end of the uncovered channel precursor, followed by volatilizing the solvent to cause the polymeric microparticles to self-assemble into an aggregate; and heating the aggregate of the polymeric microparticles so that the polymeric microparticles are partially melt-bonded to form a cluster.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating an embodiment of a microfluidic device according to the disclosure;

FIG. 2 is a flow chart illustrating an embodiment of a method of making the embodiment of the microfluidic device;

FIG. 3 is a plot illustrating the relationship between a bead-sintering ratio of polymeric microparticles and a sintering energy provided by light power applied to the polymeric microparticles;

FIG. 4 is a perspective view illustrating a blocking member disposed in an uncovered channel precursor prior to dropping of a solution into uncovered channel precursor;

FIG. 5 is a perspective view illustrating another configuration of the embodiment of the microfluidic device;

FIG. 6 is a plot illustrating the influence of porous filter length and photosintering treatment on the volume and purity of plasma separated from a whole blood sample by the microfluidic device of FIG. 4;

FIG. 7 is a plot illustrating the volume of plasma separated from different volumes of whole blood samples using the microfluidic device of FIG. 4 at different separating times; and

FIG. 8 is a schematic view illustrating the microfluidic device of FIG. 4 further incorporated with a detecting chip.

### DETAILED DESCRIPTION

A microfluidic device according to the disclosure is effective for separating an analyte from a liquid sample. The microfluidic device is adapted to be combined with a detecting chip to conduct analyte detection.

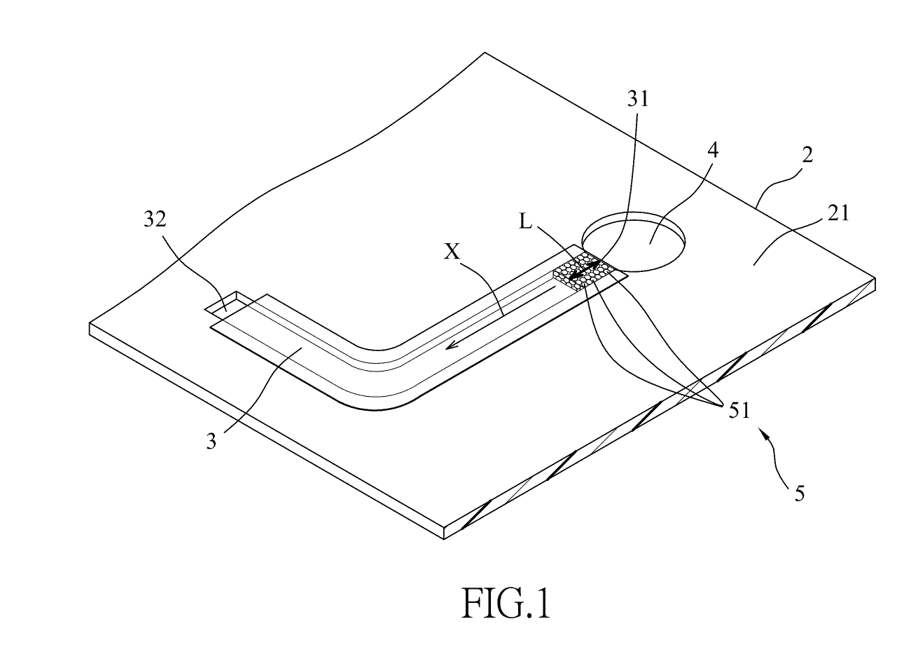

Referring to FIG. 1, an embodiment of a microfluidic device according to the disclosure includes a substrate 2, a microchannel 3, a porous filter 5, and a receptacle 4.

The substrate 2 may be made from glass or polymeric materials, e.g., cyclic olefin copolymer (COC), polymethylmethacrylate (PMMA), polydimethylsiloxane (PDMS), polycarbonate (PC), etc.

The microchannel 3 is formed in the substrate 2, and has a first open end 31 and a second open end 32 that is distal from the first open end 31.

The receptacle 4 is formed in the substrate 2 and is in fluid communication with the first open end 31 of the microchannel 3.

The porous filter 5 is disposed proximally to the first open end 31 and has a plurality of polymeric microparticles 51. In the embodiment, the porous filter 5 has a length (L) that extends along a direction (X) of a fluid flow in the microchannel 3. In one form, the length (L) of the porous filter 5 may be not less than 300 μm, and specifically in the range of from 300 μm to 800 μm.

The polymeric microparticles 51 clump together and are partially melt-bonded to each other to form a cluster. The cluster defines a plurality of pores. Each of the polymeric microparticles 51 of the porous filter 5 may have a particle size ranging from 1 μm to 10 μm. Each of the pores may have a pore size not larger than 5 μm.

The polymeric microparticles 51 of the porous filter are made from a material selected from a group consisting of polyethylene (PE), polystyrene (PS), polyacrylate, and combinations thereof. In one form, the polymeric microparticles 51 have a melting point not greater than 250° C. In one form, the polymeric microparticles 51 of the porous filter 5 are made from polyethylene (PE) that has a melting point not greater than 120° C.

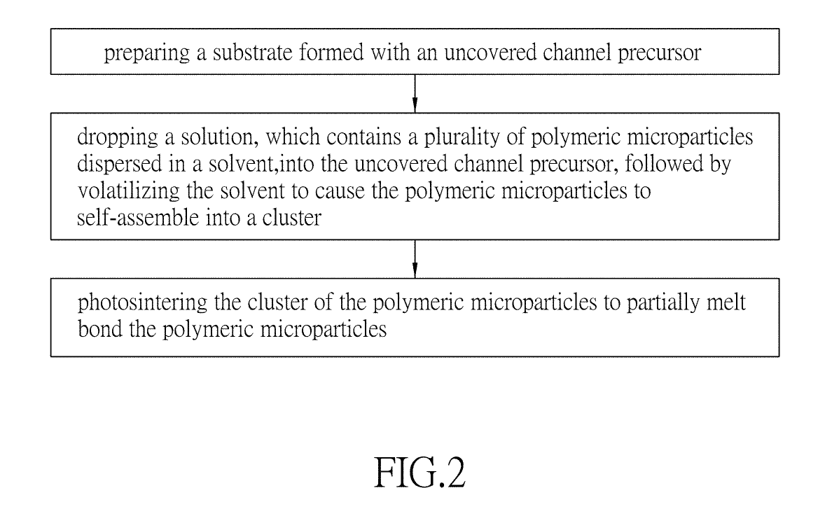

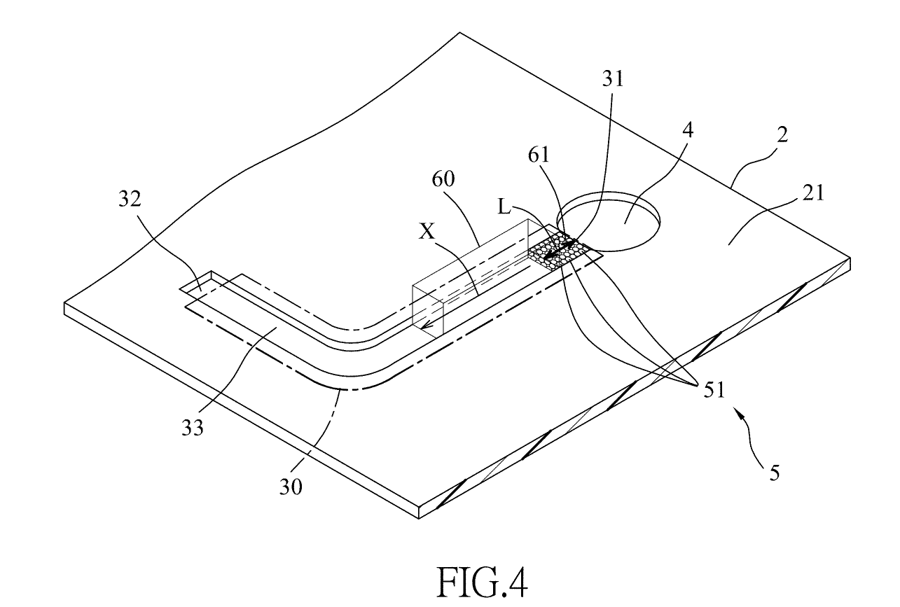

Referring to FIG. 2 in combination with FIG. 1, an embodiment of a method of making the embodiment of the microfluidic device includes preparing the substrate 2 formed with an uncovered channel precursor 33 (as shown in FIG. 4) that is indented from a top surface 21 of the substrate 2. In this embodiment, a receptacle 4 is further formed in the substrate 2 immediately adjacent to and in fluid communication with an end of the uncovered channel precursor 33. Then, a solution that contains the polymeric microparticles 51 dispersed in a solvent is dropped into a confined region (as shown in FIG. 4) proximal to the end of the uncovered channel precursor 33, followed by volatilizing the solvent to cause the polymeric microparticles 51 to self-assemble into an aggregate. Thereafter, the aggregate of the polymeric microparticles 51 is heated so that the polymeric microparticles 51 are partially melt-bonded together to form the cluster.

In one form, the uncovered channel precursor 33 and the receptacle 4 may be formed by etching, laser ablating, molding, etc.

In one form, the solvent may be selected from one of water, methanol, ethanol, propanol and combinations thereof, and volatilization of the solvent may be conducted at room temperature. Alternatively, the solvent is volatilized under a vacuum condition.

In one form, the solution may include 10 μg of the polymeric microparticles, 10 μL of water, and 10 μL of methanol.

In one form, the aggregate of the polymeric microparticles 51 are photosintered to be partially melt-bonded to form the cluster. The photosintering of the aggregate of the polymeric microparticles 51 is conducted by irradiating the aggregate with a sintering energy provided by light having a predetermined wavelength and a predetermined light power. When the sintering energy is too high, the polymeric microparticles 51 will be overly melt-bonded, causing the pore size to be too small. When the sintering energy is too low, the polymeric microparticles 51 cannot be melt-bonded.

In one form, the polymeric microparticles 51 are made from polyethylene (PE), and the photosintering of the aggregate is conducted by irradiating the aggregate with the light having the wavelength ranging from 300 nm to 1100 nm and the sintering energy ranging from 5 J/cm² to 50 J/cm².

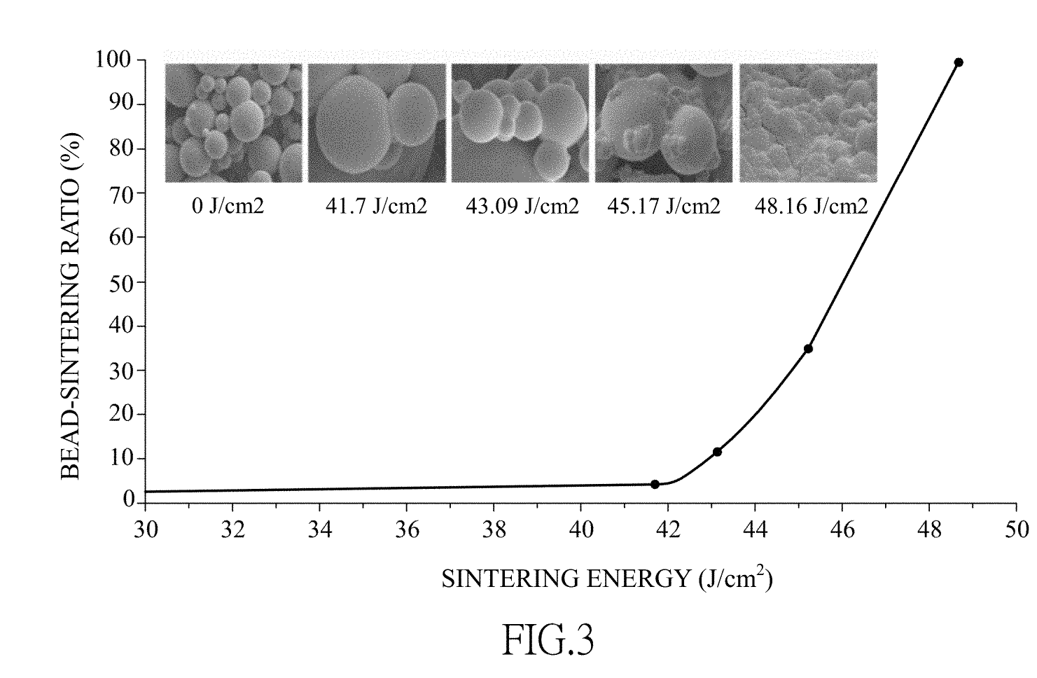

FIG. 3 illustrates a bead-sintering ratio of the polymeric microparticles 51, which is defined by a volume of melt-bonded polymeric microparticles 51 to a total volume of the polymeric microparticles 51, at different values of the sintering energy of the light used for photosintering. The light is emitted from a halogen lamp having a wavelength ranging from 300 nm to 1100 nm. The result indicates that the bead-sintering ratio of the polymeric microparticles 51 is adjustable according to the sintering energy, so as to control the pore size of the pores defined by the cluster of the partially melt-bonded polymeric microparticles 51 and thus confer a structural strength of the porous filter 5.

Optionally, a cover sheet 30 (as shown in FIG. 4) is further formed on the top surface 21 of the substrate 2 to cover the uncovered channel precursor 33 to complete the formation of the microchannel 3 (as shown in FIG. 1).

Referring to FIG. 4, In one form, prior to the dropping of the solution into the uncovered channel precursor 33, a blocking member 60 is optionally disposed in the uncovered channel precursor 33 at a position that is spaced apart from the end (such as the first end 31) of the uncovered channel precursor 33. The confined region 61 is formed between the blocking member 60 and the end of the uncovered channel precursor 33. The blocking member 60 may be made from Teflon. In this embodiment, the length (L) of the porous filter 5 formed in the confined region is substantially the same as that of the blocking member 60, and thus, the length (L) of the porous filter 5 can be adjusted by changing the position of the blocking member 60 in the uncovered channel precursor 33. In addition, since the blocking member 60 may be made from Teflon, the porous filter 5 formed after the melt bonding of the polymeric microparticles 51 can be easily separated from the blocking member 60 without damage.

Back referring to FIG. 1, when the microfluidic device of the disclosure is used in separation of a fluid sample such as a blood sample, the blood sample is first dropped into the receptacle 4, and is then driven to flow into the porous filter 5 by capillary action. Meanwhile, the blood cells of the blood sample are blocked in the porous filter 5, while plasma of the blood penetrates the porous filter 5 and flows into the microchannel 3 for subsequent detection and analysis.

It should be noted that since the polymeric microparticles 51 clump together and are partially melt-bonded to form a cluster, the resulting cluster has a relatively great structural strength and can withstand a relatively high flow resistance. Hence, the intact structure of the porous filter 5 can be maintained during flowing of the blood sample therethrough, and high plasma extraction efficiency can be achieved. Hence, the collapsing problem of the conventional microfluidic device is alleviated.

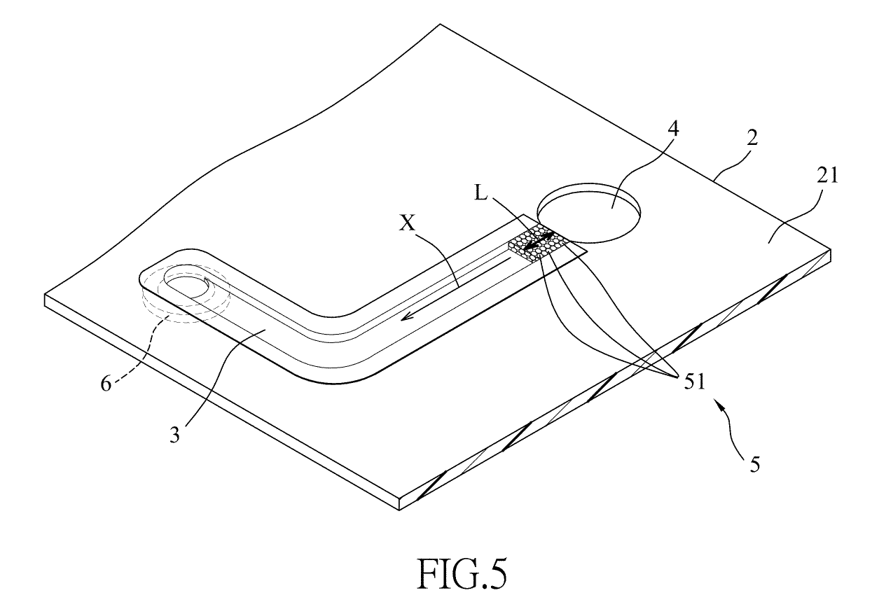

Referring to FIG. 5, another configuration of the embodiment of the microfluidic device according to the disclosure is illustrated. In this configuration, the microfluidic device further includes a suction member 6 disposed proximally to and in spatial communication with the second open end 32 of the microchannel 3. The suction member 6 is configured to supply a suction force or negative pressure to the microchannel 3, so that a test sample loaded in the microfluidic device can be driven to flow from the receptacle 4 into the microchannel 3. The suction member 6 may be a micropump, or a microfluidic dynamic device such as a microfluidic chip device disclosed in U.S. Utility Patent Application Publication No. US 2011/0247707 A1. The suction force provided by the suction member 6 allows the test sample to flow through the microchannel 3 in a relatively fast and smooth manner, thereby reducing the separation time and increasing the efficiency of plasma extraction. In addition, since the porous filter of the microfluidic device has relatively high structural strength and can withstand relatively high flow resistance, it is not necessary to consider the deformation or collapsing problem of the porous filter 5 when the suction member 6 is used for applying suction force or negative pressure to accelerate the flow of the test sample in the microchannel 3.

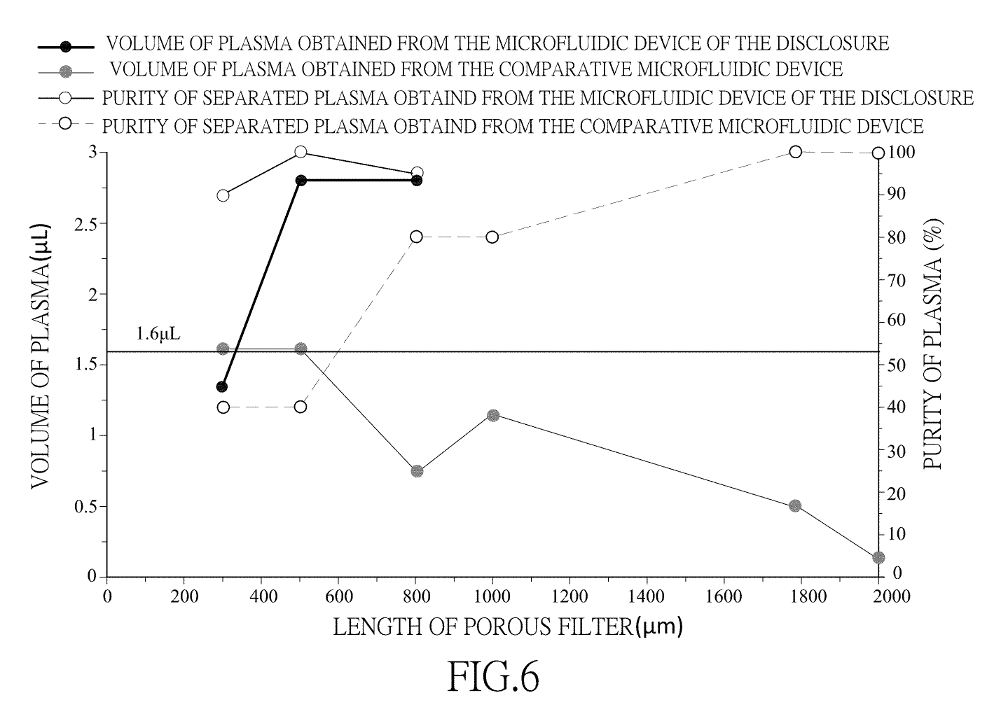

FIG. 6 illustrates results of variations on the volume and purity of plasma separated from a whole blood sample by the microfluidic device of the disclosure and a comparative microfluidic device with respect to length variations of the porous filters 5. The microfluidic device of the disclosure has a configuration shown in FIG. 5, and the comparative microfluidic device has a structure similar to the microfluidic device of the disclosure but is not subjected to the photosintering treatment. The results indicate that the purity of the plasma separated by the comparative microfluidic device is directly proportional to the length (L) of the porous filter thereof, while the volume of the plasma separated by the comparative microfluidic device is inversely proportional to the length of the porous filter. Since the structural strength of the comparative microfluidic device is relatively weak, it is evident from FIG. 6 that the porous filter of the comparative microfluidic device cannot withstand the relatively high flow resistance caused by the relatively large volume of the blood sample. Specifically, when the length of the porous filter of the comparative microfluidic device is relatively short, such as less than 300 μm, the purity of the separated plasma will be only 40%. When the length of the comparative microfluidic device is 800 μm, the purity of the separated plasma will reach 80% while the volume of the separated plasma will be only 0.6 μL. This shows that although the comparative microfluidic device can be used for separating the plasma from the blood sample, the plasma extraction efficiency is relatively low. On the contrary, since the porous filter 5 of the microfluidic device of this disclosure has relatively great structural strength, the porous filter 5 having the length of 300 μm can have a relatively high separation efficiency, i.e., the purity of the separated plasma is greater than 90% as shown in FIG. 5. Specifically, when the length (L) of the porous filter 5 is 400 μm, the purity of the separated plasma can reach almost 100% and the volume of the separated plasma can reach around 2.8 μL.

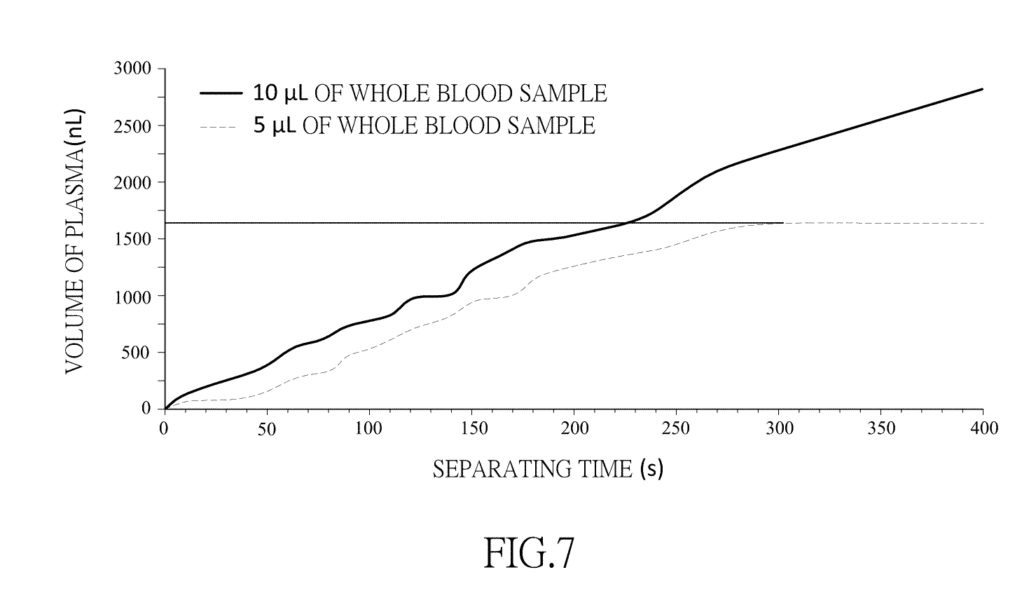

FIG. 7 illustrates the different volumes of plasma separated from 5 μL and 10 μL of whole blood samples, respectively, by the microfluidic device of FIG. 4 at different separating times. The length of the porous filter 5 of the microfluidic device is 500 μm. The results show that the separating time taken for separating 1.4 μL of plasma from 10 μL of blood sample was 4 minutes, and the separating time taken for separating 2.8 μL of plasma from 10 μL of blood sample was 5 minutes. The plasma extraction efficiency of the microfluidic device was around 44% (Hematocrit (HCT) of the blood sample is 36%). The minimum volume of the plasma used for subsequent analysis on the microfluidic device is 1.0 μL. Thus, short separating time and high purity of plasma can be obtained from a relatively small amount of blood sample when the microfluidic device of the disclosure is used.

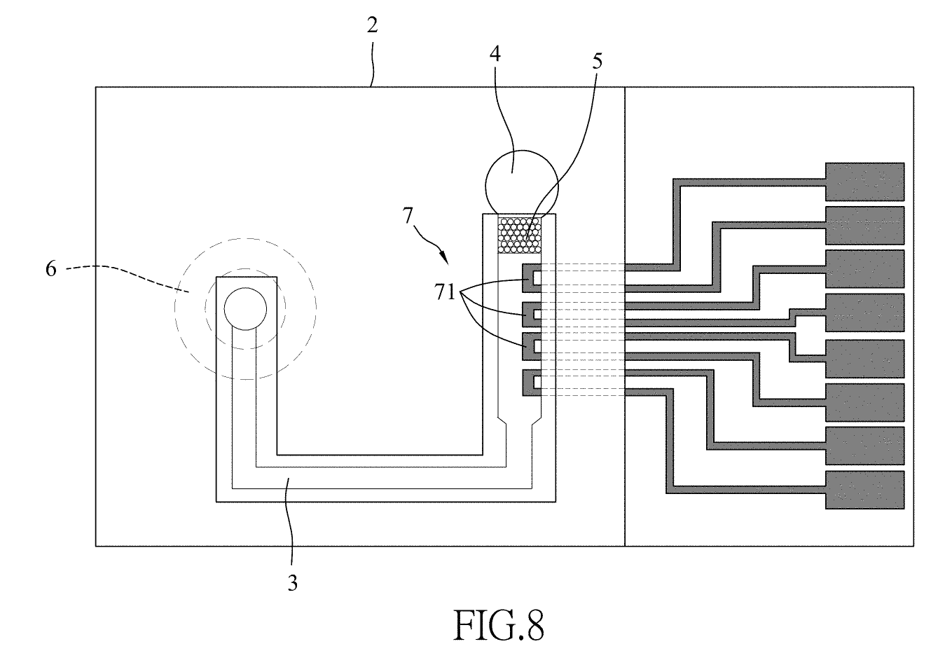

Referring to FIG. 8, the microfluidic device of the disclosure may further include a detecting chip 7. In this case, the microfluidic device is exemplified by the microfluidic device of FIG. 5. The detecting chip 7 includes a sensing electrode 71 that is disposed in the microchannel 3 downstream of the porous filter 5 and that is electrically connected to an analyzing member (not shown). The plasma separated by the porous filter 5 can be subsequently analyzed by the detecting chip 7. The detecting chip 7 can be integrated into the microfluidic device. The structure of the sensing electrode 71 is not limited to this disclosure and can be designed taking into consideration the structural arrangement of the microfluidic device put into actual practice.

To sum up, by virtue of the porous filter 5 that includes the polymeric microparticles 51 partially melt-bonded to each other, the structural strength of the porous filter 5 is increased and the filtering performance is thus improved. Therefore, a sufficient amount of analyte with high purity can be obtained from a relatively small amount of sample. In addition, with the inclusion of the suction member 6 and the integration of the detecting chip 7 into the microfluidic device, the separating rate can be improved and the analyte can be analyzed immediately after being obtained.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A microfluidic device, comprising:
a substrate;
a microchannel that is formed in said substrate and that has a first open end and a second open end distal from said first open end; and
a porous filter that is disposed proximally to said first open end and that has a plurality of polymeric microparticles clumping together and partially melt-bonded to each other to form a cluster.

2. The microfluidic device of claim 1, wherein said porous filter has a length that extends along a direction (X) of a fluid flow in said microchannel and that is not less than 300 μm.

3. The microfluidic device of claim 1, wherein said polymeric microparticles of said porous filter each have a particle size ranging from 1 μm to 10 μm.

4. The microfluidic device of claim 1, wherein said cluster defines a plurality of pores each having a pore size not larger than 5 μm.

5. The microfluidic device of claim 1, wherein said polymeric microparticles of said porous filter are made from a material selected from a group consisting of polystyrene, polyethylene, polyacrylate, adhesive epoxy, and combinations thereof.

6. The microfluidic device of claim 1, further comprising a suction member that is disposed proximally to and in spatial communication with said second open end of said microchannel.

7. The microfluidic device of claim 1, further comprising a receptacle that is formed in said substrate and that is in fluid communication with said first open end of said microchannel.

8. The microfluidic device of claim 1, further comprising a detecting chip that includes a sensing electrode disposed in said microchannel downstream of said porous filter and electrically connected to an analyzing member.

9. A method of making a microfluidic device, comprising:
preparing a substrate formed with an uncovered channel precursor that is indented from a top surface of the substrate;
dropping a solution, which contains a plurality of polymeric microparticles dispersed in a solvent, into a confined region proximal to an end of the uncovered channel precursor, followed by volatilizing the solvent to cause the polymeric microparticles to self-assemble into an aggregate; and
heating the aggregate of the polymeric microparticles so that the polymeric microparticles are partially melt-bonded to form a cluster.

10. The method of claim 9, wherein heating of the aggregate of the polymeric microparticles is carried out by photosintering.

11. The method of claim 9, wherein the polymeric microparticles have a melting point not greater than 250° C.

12. The method of claim 9, wherein the photosintering of the aggregate is conducted by irradiating the aggregate with light having a wavelength ranging from 300 nm to 1100 nm and a sintering energy ranging from 5 J/cm² to 50 J/cm².

13. The method of claim 9, further comprising disposing a blocking member in the uncovered channel precursor at a position spaced apart from the end of the uncovered channel precursor prior to the dropping of the solution into the uncovered channel precursor, wherein the confined region is formed between the blocking member and the end of the uncovered channel precursor.

14. The method of claim 13, wherein the blocking member is made from Teflon.

15. The method of claim 13, further comprising forming a receptacle in the substrate immediately adjacent to and in fluid communication with the end of the uncovered channel precursor, the confined region being interposed between the receptacle and the blocking member.

16. The method of claim 13, further comprising forming a cover sheet on the top surface of the substrate to cover the uncovered channel precursor to complete the formation of a microchannel.

17. The method of claim 9, wherein during heating of the aggregate of the polymeric microparticles, each of the polymeric microparticles is formed with an adhesive outer surface.
